(19) United States
(12) Patent Application Publication
(10) Pub. No.: US 2006/0291056 A1
(43) Pub. Date: Dec. 28, 2006

(54) Solid-state imaging device

(76) Inventors: Takahiko Murata, Osaka-fu (JP); Takumi Yamaguchi, Kyoto-fu (JP); Shigetaka Kasuga, Osaka-fu (JP)

Correspondence Address: MCDERMOTT WILL & EMERY LLP, 600 13TH STREET, N.W., WASHINGTON, DC, 20005-3096, US

(21) Appl. No.: 11/471,705

(22) Filed: Jun. 21, 2006

(30) Foreign Application Priority Data
Jun. 24, 2005 (JP) 2005-185145

(51) Int. Cl. G02B 5/30

(52) U.S. Cl. 359/486

(57) ABSTRACT

By making an aperture 13a to which light of an R (Red) component enters larger than other apertures (apertures 12a, 14a, and 15a), an attenuation ratio of light of the R component can be reduced when compared with the case where each aperture has a same size. Therefore, deterioration in sensitivity to the light of the R component can be suppressed, and deterioration in image quality can be reduced.

### BACKGROUND OF THE INVENTION

(1) Field of the Invention

The present invention relates to a solid-state imaging device for use in a digital camera and the like.

(2) Related Art

With downsizing of a digital camera, pixels in a solid-state imaging device are increasingly reduced in size. According to a latest technique, a CCD (Charge Coupled Device) solid-state imaging device has a pixel size (diagonal length) of 1.56 μm, whereas a MOS (Metal Oxide Semiconductor) solid-state imaging device has a pixel size (diagonal length) of 2.0 μm (See ISSCC (International Solid State Circuits Conference) 2005/SESSION19/IMAGERS/19.1 and ISSCC2005/SESSION19/IMAGERS/19.2).

FIG. 1 shows a structure of a CCD solid-state imaging device disclosed in ISSCC2005/SESSION19/IMAGERS/19.1.

In this CCD solid-state imaging device, an image area has 2040×1533 pixels, and realizes a 30% reduction in area compared with conventional devices.

FIG. 2 shows a structure of a MOS solid-state imaging device disclosed in ISSCC2005/SESSION19/IMAGERS/19.2.

A MOS solid-state imaging device has been believed to have a difficulty in downsizing compared with a CCD solid-state imaging device. However, the device shown in FIG. 2 overcomes this difficulty by sharing a detection circuit (Reset, Detection, and FD) with four pixels, and realizes the MOS solid-state imaging device having the pixel size of 2.0 μm.

In the conventional example shown in FIG. 2, a pixel aperture ratio is approximately 30%. If a pixel and an aperture are square-shaped, then an aperture size (diagonal length) is approximately 1.1 μm. Pixel size reduction is expected to further progress in a future.

However, if the pixel size reduction keeps on progressing, the aperture size approximates a half-wavelength of light, and an attenuation ratio of light at the aperture increases. Especially, an attenuation ratio of light of an R (Red) component, which is in a longest-wavelength band among three primary color components, increases. As a result, sensitivity to the R component extremely deteriorates, which causes deterioration in overall image quality.

### SUMMARY OF THE INVENTION

In view of the above problem, the present invention aims to provide a solid-state imaging device that can reduce deterioration in image quality caused by pixel size reduction.

A solid-state imaging device of the present invention includes: a semiconductor substrate having a plurality of light receiving areas; and a light shielding film covering the semiconductor substrate, and having a plurality of apertures which correspond in position to the plurality of light receiving areas and to each of which light in any one of a plurality of wavelength bands enters, wherein an aperture to which light in a longest-wavelength band enters is largest among the plurality of apertures.

According to the above structure, an attenuation ratio of light in a longest-wavelength band can be reduced when compared with the case where each aperture has a same size. Therefore, deterioration in sensitivity to the light in the longest-wavelength band can be suppressed, and the deterioration in image quality can be reduced.

Note also that, an aperture to which light in a longer-wavelength band enters is larger.

According to the above structure, an aperture to which light in a shorter-wavelength band enters can be reduced in size, while making sensitivity to light in all wavelength bands uniform. Therefore, an overall solid-state imaging device can be downsized.

Note also that, the solid-state imaging device may further include a plurality of microlenses corresponding in position to the plurality of light receiving areas with the plurality of apertures therebetween, and each operable to collect light to a corresponding light receiving area, wherein among the plurality of microlenses, a microlens corresponding to a larger aperture may have a larger light collecting area.

According to the above structure, an amount of incident light in a longest-wavelength band can be increased when compared with the case where each light collecting area of each microlens has a same size. Therefore, deterioration in sensitivity to the light in the longest-wavelength band can be further suppressed.

A solid-state imaging device of the present invention includes: a semiconductor substrate having a plurality of light receiving areas; a light shielding film covering the semiconductor substrate, and having a plurality of apertures which correspond in position to the plurality of light receiving areas and to each of which light in any one of a plurality of wavelength bands enters; and a plurality of microlenses corresponding in position to the plurality of light receiving areas with the plurality of apertures therebetween, and each operable to collect light to a corresponding light receiving area, wherein a microlens corresponding to an aperture to which light in a longest-wavelength band enters has a largest light collecting area among the plurality of microlenses.

According to the above structure, an amount of the incident light in the longest-wavelength band can be increased when compared with the case where each light collecting area of each microlens has a same size. As a result, even when an attenuation ratio of light at an aperture is higher, a decrease of an amount of received light at a light receiving area can be suppressed. Therefore, the deterioration in sensitivity to the light in the longest-wavelength band can be suppressed, and the image quality deterioration can be reduced.

Note also that, among the plurality of microlenses, a microlens corresponding to an aperture to which light in a longer-wavelength band enters may have a larger light collecting area.

According to the above structure, all pixels can be reduced in size, while making the sensitivity to the light in all wavelength bands uniform. Therefore, the overall solid-state imaging device can be downsized.

A solid-state imaging device of the present invention includes a plurality of pixels each receiving light in any one of a plurality of wavelength bands, wherein a number of pixels receiving light in a longest-wavelength band is greatest among the plurality of pixels.

According to the above structure, a proportion of the pixels receiving the light in the longest-wavelength band in all pixels is greater compared with conventional techniques. Therefore, the deterioration in sensitivity to the light in the longest-wavelength band can be suppressed, and the deterioration in image quality can be reduced.

Note also that, among the plurality of pixels, a number of pixels receiving light in a longer-wavelength band may be greater.

According to the above structure, all pixels can be reduced in size, while making the sensitivity to the light in all wavelength bands uniform. Therefore, the overall solid-state imaging device can be downsized.

A solid-state imaging device of the present invention includes: a semiconductor substrate having a plurality of light receiving areas; a light shielding film covering the semiconductor substrate, and having a plurality of apertures which correspond in position to the plurality of light receiving areas; and a filter operable to have each of the plurality of light receiving areas receive light in a wavelength band specified for the light receiving area, wherein an aperture corresponding to a light receiving area for receiving light in a longest-wavelength band is largest among the plurality of apertures.

According to the above structure, an attenuation ratio of light in a longest-wavelength band can be reduced when compared with the case where each aperture has a same size. Therefore, deterioration in sensitivity to the light in the longest-wavelength band can be suppressed, and the deterioration in image quality can be reduced. Note that the filter may have any positional relation with the light shielding film, as long as the filter is closer to a light source than the semiconductor substrate.

A solid-state imaging device of the present invention includes: a semiconductor substrate having a plurality of light receiving areas; a light shielding film covering the semiconductor substrate, and having a plurality of apertures which correspond in position to the plurality of light receiving areas and to each of which light in any one of a plurality of wavelength bands enters; a plurality of microlenses corresponding in position to the plurality of light receiving areas with the plurality of apertures therebetween, and each operable to collect light to a corresponding light receiving area; and a filter operable to have each of the plurality of light receiving areas receive light in a wavelength band specified for the light receiving area, wherein a microlens corresponding to a light receiving area for receiving light in a longest-wavelength band has a largest light collecting area among the plurality of microlenses.

According to the above structure, an amount of the incident light in the longest-wavelength band can be increased when compared with the case where each light collecting area of each microlens has a same size. As a result, even when an attenuation ratio of light at an aperture is higher, a decrease of an amount of received light at a light receiving area can be suppressed. Therefore, the deterioration in sensitivity to the light in the longest-wavelength band can be suppressed, and the image quality deterioration can be reduced. Note that the filter may have any positional relation with the light shielding film, as long as the filter is closer to a light source than the semiconductor substrate.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows a structure of a conventional CCD solid-state imaging device disclosed in ISSCC2005/SESSION19/IMAGERS/19.1;

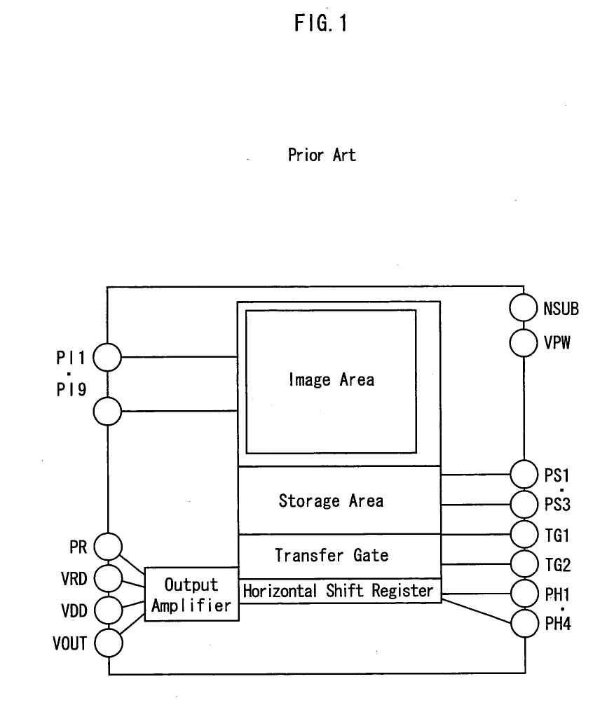

FIG. 2 shows a structure of a conventional MOS solid-state imaging device disclosed in ISSCC2005/SESSION19/IMAGERS/19.2;

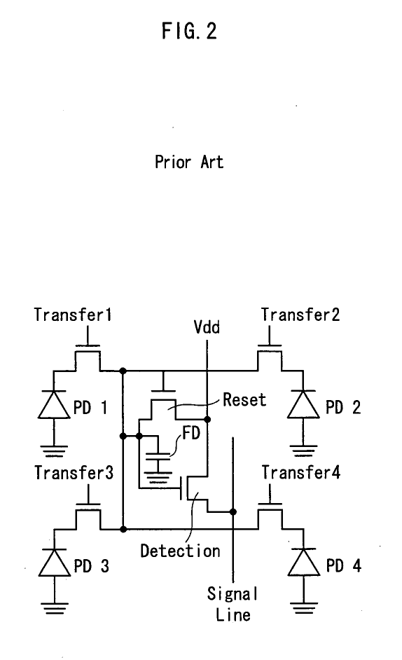

FIG. 3 is a schematic sectional view showing a solid-state imaging device;

FIG. 4 shows a light shielding film of the solid-state imaging device according to a first embodiment, as shown from above;

FIG. 5 shows a spectral characteristic of a color filter;

FIG. 6 shows wavelength dependence of an attenuation ratio of light at an aperture according to the first embodiment;

FIG. 7 shows a light shielding film of a solid-state imaging device according to a second embodiment, as shown from above;

FIG. 8 shows wavelength dependence of an attenuation ratio of light at an aperture according to the second embodiment;

FIG. 9 shows the light shielding film together with a microlens of the solid-state imaging device according to the second embodiment, as shown from above;

FIG. 10 shows a light shielding film together with a microlens of a solid-state imaging device according to a third embodiment, as shown from above;

FIG. 11 shows a light shielding film together with a microlens of a solid-state imaging device according to a fourth embodiment, as shown from above;

FIG. 12 shows a light shielding film of a solid-state imaging device according to a fifth embodiment, as shown from above; and

FIG. 13 shows a light shielding film of a solid-state imaging device according to a sixth embodiment, as shown from above.

### DESCRIPTION OF THE PREFERRED EMBODIMENTS

Preferred embodiments of the present invention will now be described with reference to the drawings.

### First Embodiment

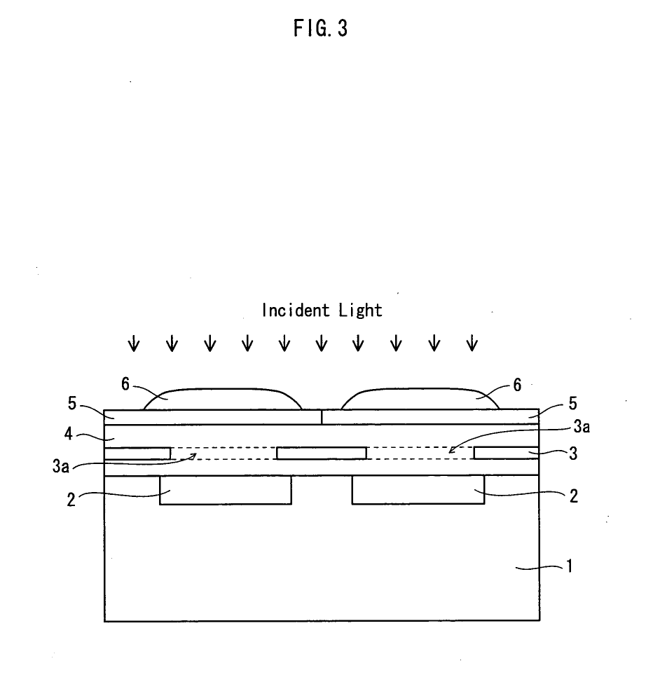

FIG. 3 is a schematic sectional view showing a solid-state imaging device.

Note here that only two pixels are shown in the drawing. The solid-state imaging device includes a semiconductor substrate 1, a light shielding film 3, an interlayer insulating film 4, a color filter 5, and a microlens 6. The semiconductor substrate 1 has a plurality of light receiving areas 2. Each of the light receiving areas 2 generates an electric charge according to an amount of received light, and accumulates the generated electric charge. The light shielding film 3 covers the semiconductor substrate 1, and has a plurality of apertures 3a corresponding in position to the plurality of light receiving areas 2. A component, which is transmitted through the color filter 5, among components of incident light, enters to the aperture 3a. The color filter 5 is sectionalized for each pixel, and transmits light in a wavelength band prescribed for each pixel (also referred to as “for each light receiving area” because one pixel has one light receiving area). The microlens 6 is arranged for each pixel, and collects incident light to each of the light receiving areas 2. The interlayer insulating film 4 is made of a material having both translucency and insulation property.

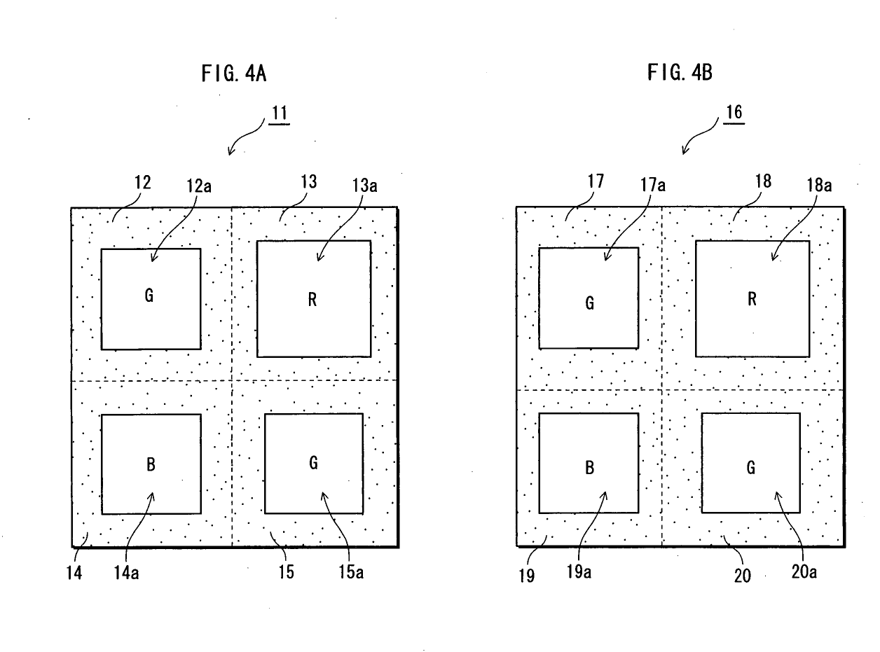

FIG. 4 shows a light shielding film of the solid-state imaging device according to a first embodiment, as shown from above.

Note here that only four pixels are shown in the drawing. Also, the color filter 5 is supposed to have a three primary color Bayer arrangement.

A light shielding film 11 has an aperture (apertures 12a to 15a) for each pixel (pixels 12 to 15). Each of alphabets “R” (Red), “G” (Green), and “B” (Blue) given to a corresponding pixel in FIG. 4 shows a kind of a component of light received by the pixel. The first embodiment has a characteristic feature that an aperture of a pixel receiving an R component (an R pixel) is larger than those of pixels receiving other components (a G pixel and a B pixel). In an example shown in FIG. 4A, the aperture 13a of the R pixel is larger than the apertures 12a, 14a, and 15a of the other pixels. The apertures 12a, 14a, and 15a have a same size.

FIG. 4A shows an example where each pixel has a same size. Alternatively, each pixel may have a different size as shown in FIG. 4B. In FIG. 4B, too, an aperture 18a of an R pixel is larger than apertures 17a and 20a of G pixels and an aperture 19a of a B pixel.

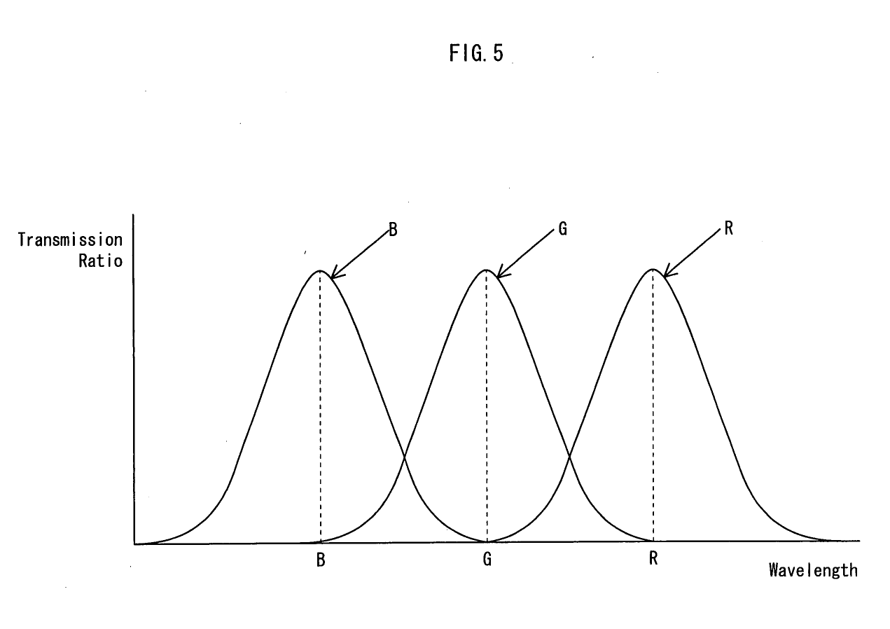

FIG. 5 shows a spectral characteristic of the color filter 5.

According to the spectral characteristic shown in FIG. 5, light in a wavelength band specified for a corresponding light receiving area, among wavelength bands of R, G, and B, enters to each aperture.

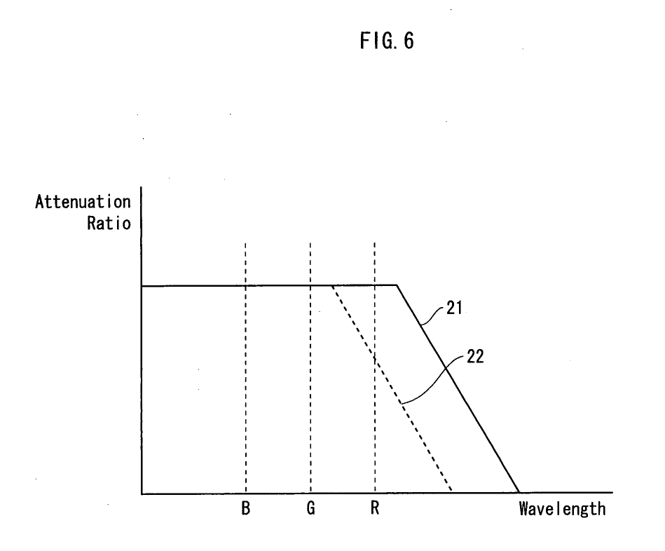

FIG. 6 shows wavelength dependence of an attenuation ratio of light at an aperture.

A curve 21 shows an attenuation ratio of light at the aperture 13a in FIG. 4A. A curve 22 shows an attenuation ratio of light at each of the apertures 12a, 14a, and 15a in FIG. 4A. According to this, the attenuation ratio of light of the R component at the aperture 13a, the attenuation ratio of light of the G component at each of the apertures 12a and 15a, and the attenuation ratio of light of the B component at the aperture 14a are substantially equal to each other.

On the other hand, if the size of the aperture 13a is the same as those of the other apertures, the attenuation ratio of light of the R component is higher than those of the other components, according to the curve 22. This causes lower sensitivity to the R component than the other components.

In the first embodiment, such a reduction in sensitivity to the R component is suppressed by making the aperture of the R pixel larger than those of the other pixels, thereby reducing image quality deterioration.

### Second Embodiment

In a second embodiment, an aperture of a light shielding film to which light in a longer-wavelength band enters is larger. Apart from this, the second embodiment has the same structure as the first embodiment, and so the following description will focus on the difference from the first embodiment.

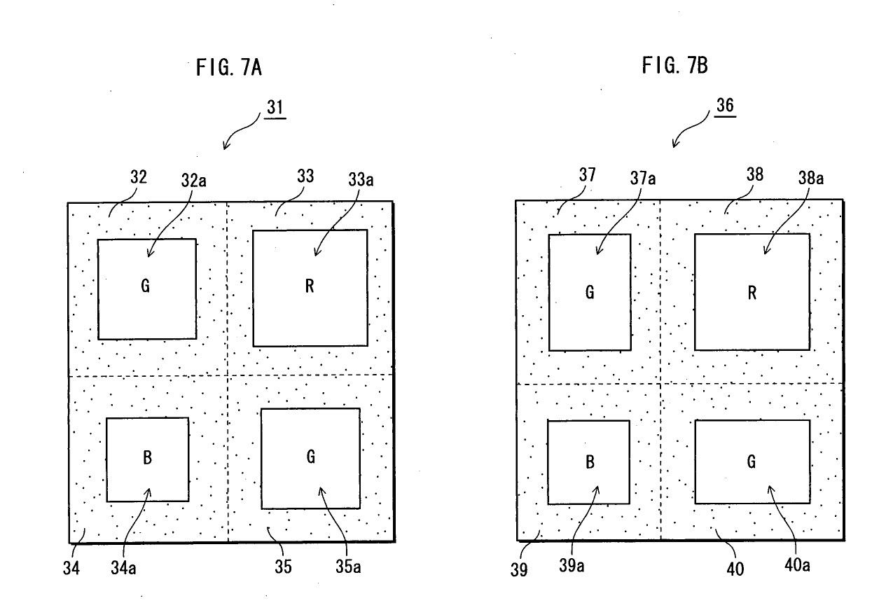

FIG. 7 shows a light shielding film of a solid-state imaging device according to the second embodiment, as shown from above.

A light shielding film 31 has an aperture (apertures 32a to 35a) for each pixel (pixels 32 to 35). The second embodiment has a characteristic feature that the aperture size decreases in an order of R, G, and B.

In an example shown in FIG. 7A, the aperture size decreases in an order of the apertures 33a, 32a and 35a, and 34a. Here, the apertures 32a and 35a have a same size.

FIG. 7A shows an example where each pixel has a same size. Alternatively, each pixel may have a different size as shown in FIG. 7B. In FIG. 7B, too, the aperture size decreases in an order of an aperture 38a of an R pixel, apertures 37a and 40a of G pixels, and an aperture 39a of a B pixel.

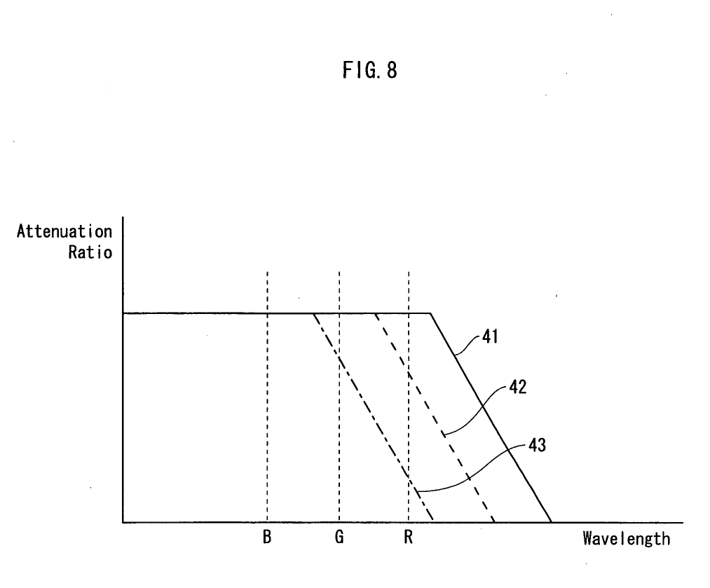

FIG. 8 shows wavelength dependence of an attenuation ratio of light at an aperture.

A curve 41 shows an attenuation ratio of light at the aperture 33a in FIG. 7A. A curve 42 shows an attenuation ratio of light at each of the apertures 32a and 35a in FIG. 7A. A curve 43 shows an attenuation ratio of light at the aperture 34a in FIG. 7A. According to this, the attenuation ratio of light of the R component at the aperture 33a, the attenuation ratio of light of the G component at each of the apertures 32a and 35a, and the attenuation ratio of light of the B component at the aperture 34a are substantially equal to each other.

In the second embodiment, as well as in the first embodiment, such a reduction in sensitivity to the R component is suppressed by making the aperture of the R pixel larger than those of the other pixels, thereby reducing image quality deterioration. Furthermore, in the second embodiment, the aperture size decreases in the order of R, G, and B. In this way, an aperture of a pixel receiving light in a shorter-wavelength band can be made smaller, while making sensitivity to light in all wavelength bands uniform. As a result, the overall solid-state imaging device can be downsized.

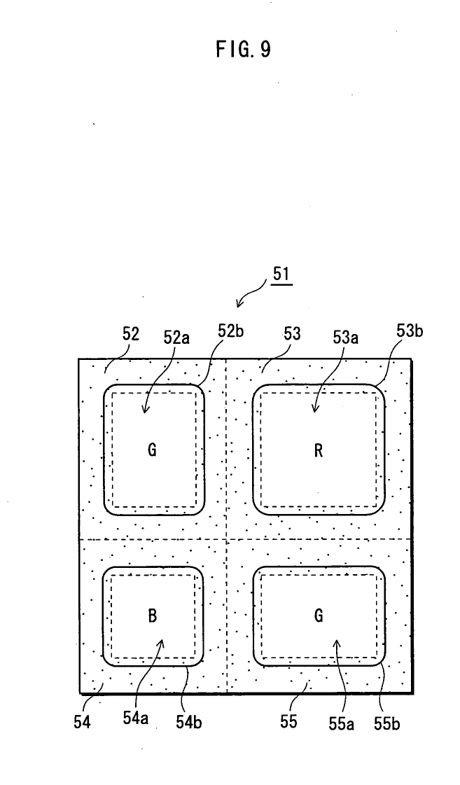

FIG. 9 shows the light shielding film together with a microlens of the solid-state imaging device according to the second embodiment, as shown from above.

The imaging device has a microlens (microlenses 52b to 55b) for each pixel (pixels 52 to 55). As shown in FIG. 9, a microlens corresponding to a larger aperture has a larger light collecting area. According to this, an amount of incident light in a longer-wavelength band can be increased, when compared with the case where each light collecting area of each microlens has a same size. As a result, the deterioration in sensitivity to the R component can be further suppressed.

### Third Embodiment

A third embodiment differs from the first embodiment in the structure of the light shielding film and the microlens. Apart from this, the third embodiment has the same structure as the first embodiment, and so the following description will focus on the difference from the first embodiment.

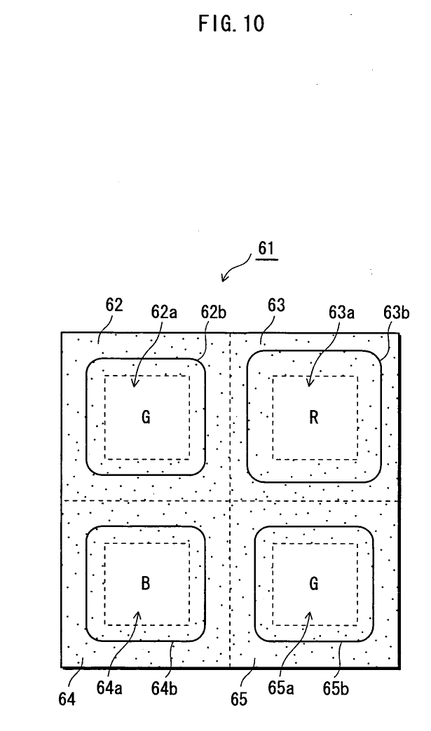

FIG. 10 shows the light shielding film together with the microlens of a solid-state imaging device according to the third embodiment, as shown from above.

A light shielding film 61 has an aperture (apertures 62a to 65a) for each pixel (pixels 62 to 65). Each aperture has a same size. The solid-state imaging device has a microlens (microlenses 62b to 65b) for each pixel (the pixels 62 to 65). The third embodiment has a characteristic feature that a microlens of an R pixel has a larger light collecting area than those of other pixels. In the example shown in FIG. 10, the microlens 63b has a larger light collecting area than the microlenses 62b, 64b, and 65b. The light collecting areas of the microlenses 62b, 64b, and 65b have a same size.

When each aperture of the pixels has a same size, an attenuation ratio of light of the R component is higher than those of the other components (See the curve 22 shown in FIG. 6).

In the third embodiment, even when the attenuation ratio of light of the R component at the aperture is higher, the light collecting area of the microlens of the R pixel is enlarged to thereby reduce a decrease of the amount of received light or increase the amount of received light. Therefore, the deterioration in sensitivity to the R component can be suppressed, and deterioration in image quality can be reduced.

### Fourth Embodiment

In a fourth embodiment, a microlens corresponding to an aperture to which light in a longer-wavelength band enters has a larger light collecting area. Apart from this, the fourth embodiment has the same structure as the third embodiment, and so the following description will focus on the difference from the third embodiment.

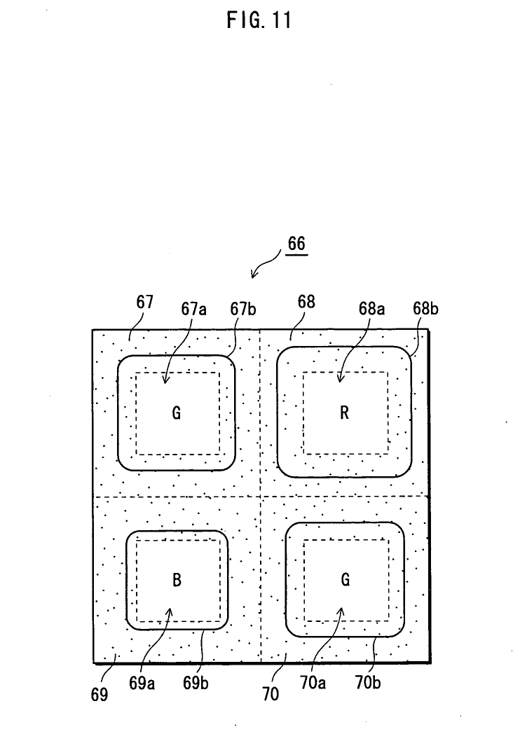

FIG. 11 shows a light shielding film together with a microlens of a solid-state imaging device according to the fourth embodiment, as shown from above.

The solid-state imaging device has a microlens (microlenses 67b to 70b) for each pixel (pixels 67 to 70). The fourth embodiment has a characteristic feature that a size of the light collecting areas of the microlenses decreases in the order of the pixels of R, G, and B. In an example shown in FIG. 11, the size of the light collecting areas decreases in an order of the microlenses 68b, 67b and 70b, and 69b. Here, light collecting areas of the microlenses 67b and 70b have a same size.

In the fourth embodiment, as well as in the third embodiment, such a reduction in sensitivity to the R component is suppressed by making the light collecting area of the microlens of the R pixel larger than those of the other pixels, thereby reducing deterioration in image quality. Furthermore, in the fourth embodiment, the size of the light collecting area of the microlens decreases in the order of R, G, and B. In this way, all pixels can be reduced in size, while making sensitivity to light in all wavelength bands uniform. As a result, the overall solid-state imaging device can be downsized.

### Fifth Embodiment

A fifth embodiment differs from the first embodiment in the color filter arrangement. Apart from this, the fifth embodiment has the same structure as the first embodiment, and so the following description will focus on the difference from the first embodiment.

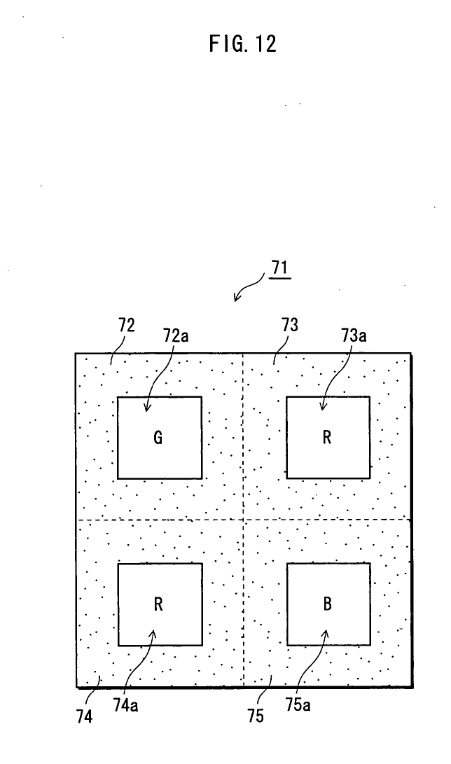

FIG. 12 shows a light shielding film of a solid-state imaging device according to the fifth embodiment, as shown from above.

A light shielding film 71 has an aperture (apertures 72a to 75a) for each pixel (pixels 72 to 75). Each of the apertures has a same size. The fifth embodiment has a characteristic feature that the number of R pixels is greater than that of G pixels, and that of B pixels. In an example shown in the FIG. 12, the number of R pixels is two, the number of G pixels is one, and the number of B pixels is one.

When each aperture of the pixels has a same size, an attenuation ratio of light of the R component is higher than those of the other components (See the curve 22 shown in FIG. 6).

In the fifth embodiment, even when the attenuation ratio of light of the R component at the aperture is higher, a proportion of the R pixels in all pixels is increased to thereby improve accuracy of an interpolation process and the like, with it being possible to reduce deterioration in image quality.

### Sixth Embodiment

In a sixth embodiment, the number of pixels receiving light in a longer-wavelength band is greater. Apart from this, the sixth embodiment has the same structure as the fifth embodiment, and so the following description will focus on the difference from the fifth embodiment.

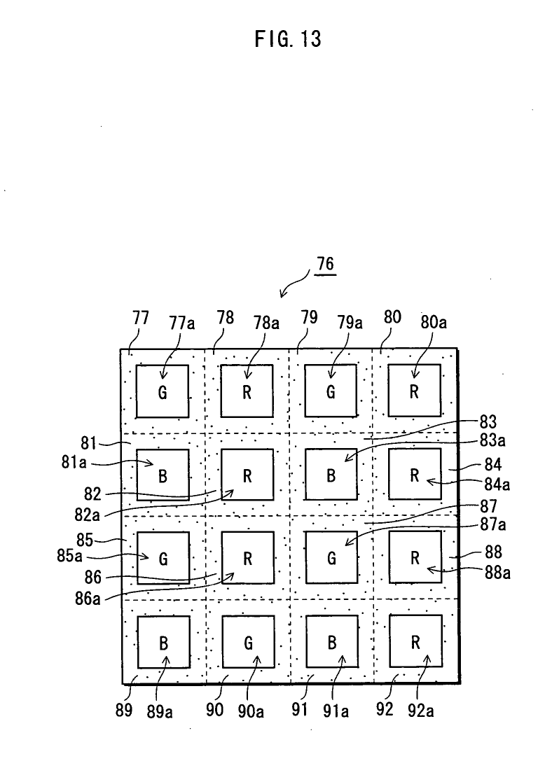

FIG. 13 shows a light shielding film of a solid-state imaging device according to the sixth embodiment, as shown from above.

Note here that 16 pixels are shown in the drawing. The sixth embodiment has a characteristic feature that the number of pixels receiving light in a longer-wavelength band is greater. In an example shown in the FIG. 13, the number of R pixels is seven, the number of G pixels is five, and the number of B pixels is four.

According to the above structure, an attenuation ratio of light at an aperture to which light in a longer-wavelength band is higher. Therefore, a total amount of received light for each wavelength band can be increased accordingly.

In the sixth embodiment, as well as in the fifth embodiment, deterioration in sensitivity can be suppressed by making the number of R pixels larger than those of other pixels. Furthermore, in the sixth embodiment, the number of pixels decreases in the order of R, G, and B. In this way, all pixels can be reduced in size, while making the sensitivity to each color uniform. As a result, the overall solid-state imaging device can be downsized.

While the solid-state imaging device according to the present invention has been described based on the above embodiments, the present invention is not limited to these embodiments. For example, the present invention may include the following variations.

(1) In the first embodiment, the aperture size is adjusted so that each of the attenuation ratios of light of the components of R, G, and B is nearly equal. However, each of the attenuation ratios of light needs not to be made equal to reduce the deterioration in image quality. If the aperture is enlarged even to a small extent, the amount of incident light increases accordingly. Therefore, the effect of suppressing the deterioration in sensitivity to the R component can be achieved, as long as the aperture of the R pixel is larger than those of the other pixels. The same applies to the second embodiment.

(2) In the first embodiment, the aperture of the R pixel is larger than those of the G and B pixels. However, the present invention is not limited to this example, as long as the aperture of the R pixel is largest. For example, the apertures of the R and G pixels may have a same size, with the aperture of the B pixel being smaller than those of the R and G pixels.

(3) In the third embodiment, the microlens of the R pixel has a larger light collecting area than those of the other pixels. However, the present invention is not limited to this. The deterioration in sensitivity to the R component can be suppressed, as long as the microlens of the R pixel has a largest light collecting area among those of the plurality of pixels. For example, light collecting areas of the microlenses of the R and G pixels may have a same size, with the microlens of the B pixel being smaller than those of the R and G pixels.

(4) In the fifth embodiment, the number of R pixels is greater than those of the other pixels. However, the present invention is not limited to this. The deterioration in sensitivity to the R component can be suppressed, as long as the number of R pixels is greatest among pixels receiving a plurality of color components. For example, the number of R pixels may be equal to the number of G pixels, with the number of B pixels being less than those of R and G pixels.

(5) The first embodiment describes an example of a three primary color filter. However, the present invention is not limited to this. For example, a complementary color filter (Cyan, Magenta, Yellow, and Green) may be also used. In this case, a pixel receiving light containing a greatest amount of a longer-wavelength component has a largest aperture. The same applies to the second embodiment.

Also, in the third and fourth embodiments, the complementary color filter may be used, as long as a pixel receiving light containing a greatest amount of a longer-wavelength component has a largest light collecting area of a microlens.

Also, in the fifth and sixth embodiments, the complementary color filter may be used, as long as the number of pixels receiving light containing a greatest amount of a longer-wavelength component is greatest.

(6) Any combination of a plurality of embodiments among the first to sixth embodiments is also possible.

(7) In the first to sixth embodiments, the color filter is closer to a light source than the light shielding film is. However, the present invention is not limited to this, as long as the color filter is closer to the light source than the semiconductor substrate is. For example, the color filter may be between the light shielding film and the semiconductor substrate.

Although the present invention has been described by way of examples with reference to the accompanying drawings, it is to be noted that various changes and modifications will be apparent to those skilled in the art. Therefore, unless otherwise such changes and modifications depart from the scope of the present invention, they should be constructed as being included therein.

What is claimed is:

1. A solid-state imaging device comprising:
a semiconductor substrate having a plurality of light receiving areas; and
a light shielding film covering the semiconductor substrate, and having a plurality of apertures which correspond in position to the plurality of light receiving areas and to each of which light in any one of a plurality of wavelength bands enters, wherein
an aperture to which light in a longest-wavelength band enters is largest among the plurality of apertures.

2. The solid-state imaging device of claim 1, wherein
an aperture to which light in a longer-wavelength band enters is larger.

3. The solid-state imaging device of claim 1 further comprising
a plurality of microlenses corresponding in position to the plurality of light receiving areas with the plurality of apertures therebetween, and each operable to collect light to a corresponding light receiving area, wherein
among the plurality of microlenses, a microlens corresponding to a larger aperture has a larger light collecting area.

4. A solid-state imaging device comprising:
a semiconductor substrate having a plurality of light receiving areas;
a light shielding film covering the semiconductor substrate, and having a plurality of apertures which correspond in position to the plurality of light receiving areas and to each of which light in any one of a plurality of wavelength bands enters; and
a plurality of microlenses corresponding in position to the plurality of light receiving areas with the plurality of apertures therebetween, and each operable to collect light to a corresponding light receiving area, wherein
a microlens corresponding to an aperture to which light in a longest-wavelength band enters has a largest light collecting area among the plurality of microlenses.

5. The solid-state imaging device of claim 4, wherein
among the plurality of microlenses, a microlens corresponding to an aperture to which light in a longer-wavelength band enters has a larger light collecting area.

6. A solid-state imaging device comprising
a plurality of pixels each receiving light in any one of a plurality of wavelength bands, wherein
a number of pixels receiving light in a longest-wavelength band is greatest among the plurality of pixels.

7. The solid-state imaging device of claim 6, wherein
among the plurality of pixels, a number of pixels receiving light in a longer-wavelength band is greater.

8. A solid-state imaging device comprising:
a semiconductor substrate having a plurality of light receiving areas;
a light shielding film covering the semiconductor substrate, and having a plurality of apertures which correspond in position to the plurality of light receiving areas; and
a filter operable to have each of the plurality of light receiving areas receive light in a wavelength band specified for the light receiving area, wherein
an aperture corresponding to a light receiving area for receiving light in a longest-wavelength band is largest among the plurality of apertures.

9. A solid-state imaging device comprising:
a semiconductor substrate having a plurality of light receiving areas;
a light shielding film covering the semiconductor substrate, and having a plurality of apertures which correspond in position to the plurality of light receiving areas and to each of which light in any one of a plurality of wavelength bands enters;
a plurality of microlenses corresponding in position to the plurality of light receiving areas with the plurality of apertures therebetween, and each operable to collect light to a corresponding light receiving area; and
a filter operable to have each of the plurality of light receiving areas receive light in a wavelength band specified for the light receiving area, wherein
a microlens corresponding to a light receiving area for receiving light in a longest-wavelength band has a largest light collecting area among the plurality of microlenses.
